(19) United States
(12) Patent Application Publication
(10) Pub. No.: US 2007/0132902 A1
(43) Pub. Date: Jun. 14, 2007

(54) LCD AND METHOD OF MANUFACTURING THE SAME

(75) Inventor: Chi-Wen Yao, Tao Yuan Shien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: QUANTA DISPLAY INC., Tao Yuan Shien (TW)

(21) Appl. No.: 11/456,580

(22) Filed: Jul. 11, 2006

(30) Foreign Application Priority Data
Dec. 14, 2005 (TW) 94144249

(51) Int. Cl. G02F 1/136

(52) U.S. Cl. 349/43

(57) ABSTRACT

A LCD is disclosed, including a gate line formed on an insulating substrate with a segment having one side protruding to form a protrusion region and an indentation region facing the protrusion region, an active layer formed on the segment of the gate line, a pixel electrode formed on the protruding side of the segment, a source line extending substantially perpendicular to the gate line to cross the overlapped region of the active layer and the gate line and prolonging beyond the edges of the active layer, and a drain line coupled to the pixel electrode and extending substantially parallel to the source line to cross the overlapped region of the active layer and the gate line The LCD is capable of preventing deviation in gate-drain parasitic capacitance to reduce difference in luminance between divisional exposure regions. The invention further discloses a method for manufacturing the same.

### BACKGROUND OF THE INVENTION

1. Field of the Invention

The invention relates to a liquid crystal display (LCD) and more particularly to a structure for a LCD capable of suppressing variation in gate-drain parasitic capacitance.

2. Description of the Related Art

Flat panel displays, especially LCDs, have advanced in recent years and gradually take the place of traditional cathode ray tube (CRT) displays. Active matrix LCDs utilizing thin film transistors (TFTs) occupy a major portion of LCDs due to display performance better than passive matrix LCD, and have become the focus of current research.

FIG. 1 is a plane view of a pixel unit 10 in a conventional TFT-LCD. The pixel unit comprises a gate line 11 disposed horizontally on an insulating substrate, wherein the gate line 11 has a protruding region serving as a gate electrode 12. An active layer, formed of amorphous silicon or the like, is formed on the gate electrode 12. A source line 14 extends perpendicularly across the gate line 11 and has a protruding region acting as a source electrode 15. A drain line 16 connected to a pixel electrode 18 extends in parallel with the gate line 11 to cross the gate electrode 12 and has a drain electrode 17. The pixel electrode 18 is generally formed of a transparent conductive material having good conductivity, such as indium-tin-oxide or indium-zinc oxide.

During photolithography, machine variance causes the overlapped region of source electrode 15/drain electrode 17 and the gate electrode 12 to exceed allowances. FIG. 2 is a plane view of the pixel unit 10 in which the source electrode 15/drain electrode 17 deviating to the right due to the exposure process. Compared to FIG. 1, the overlapped region of the source electrode 15 and the gate electrode 12 is larger while the overlapped region of the drain electrode 17 and the gate electrode 12 is smaller in FIG. 2. Accordingly, in FIG. 2 the gate-source parasitic capacitance (hereafter referred to as C_{GS}) is increased while gate-drain parasitic capacitance (hereafter referred to as C_{GD}) is decreased. Conversely, when the deviations of the exposure process cause the source electrode 15 and the drain electrode 17 deviate to the left (not shown by a figure), C_{GS} is decreased while C_{GD} is increased.

FIG. 3 shows an equivalent circuit of a pixel unit in a TFT-LCD to illustrate the effect of C_{GD} on LCD illumination. G represents a gate electrode, S represents a source electrode, D represents a drain electrode, C_{LC} represents a liquid crystal capacitance, and C_{S} represents a storage capacitance, wherein the two capacitances C_{LC} and C_{S} are connected in parallel between a pixel electrode P and a common electrode C. When the TFT-LCD is turned on, the gate electrode G is applied with a relatively high voltage V_{GH}, and the relation between the total charge Q₁ in the TFT-LCD and voltage V_{P1} of the pixel P is expressed as:
Q₁=C_{GD}(V_{P1}−V_{GH})+(C_{LC}+C_{S})(V_{P1}−V_{COM}) (1),
wherein V_{COM} denotes the voltage of the common electrode.

Conversely, when the TFT-LCD is turned off, the gate electrode G is applied with a relatively low voltage V_{GL}, and the relation between the total charge Q₂ in the TFT-LCD and the voltage V_{P2} at the pixel P is expressed as:
Q₂=C_{GD}(V_{P2}−V_{GL})+(C_{LC}+C_{S})(V_{P2}−V_{COM}) (2).

Due to charge conservation, that is, Q₁=Q₂, it is derived from formulae (1) and (3) as:

$$\begin{matrix}Δ {V}_{P} ≡ {V}_{P 1} - {V}_{P 2} \\ = ( {V}_{GH} - {V}_{GL} ) ( {C}_{GD} / ( {C}_{CL} + {C}_{CS} + {C}_{GD} ) ) .\end{matrix} \qquad ( 3 )$$

As shown in formula (3), ΔVₚ, so-called kickback voltage, is dependent on C_{GD}. Since LCD illustration is controlled by adjusting the voltage of the pixel P, there arises a problem with non-uniformity of LCD illumination deviation of C_{GD} caused by machine variance. In more serious cases, so-called “mura” phenomenon occurs. However, resolution of exposure machines is restricted within some range. Consequently, non-uniformity of LCD illustration occurs.

In consideration of the above-mentioned problem, a structure for a TFT-LCD capable of suppressing a variation in gate-drain parasitic capacitance, preventing illumination non-uniformity and enhancing display quality is called for.

### BRIEF SUMMARY OF THE INVENTION

The invention discloses a TFT-LCD capable of preventing deviation in gate-drain parasitic capacitance, thereby reducing difference in luminance between divisional exposure regions of a LCD. The invention further discloses a method for manufacturing the same.

The invention provides a LCD comprising a gate line, an active layer, a pixel electrode, a source line, and a drain line. The gate line is formed on an insulating substrate, and has a segment with one side protruding to form a protrusion region and an indentation region facing the protrusion region. The active layer is formed on the segment of the gate line. The pixel electrode is formed on the protruding side of the segment. The source line extends substantially perpendicular to the extension direction of the gate line, across the overlapped region of the active layer and the gate line, and beyond the edges of the active layer. The drain line, coupled to the pixel electrode, extends substantially parallel to the extension direction of the source line to cross the overlapped region of the active layer and the gate line.

The invention provides another LCD comprising a gate line, first and second active layers, first and second pixel electrodes, a source line, and first and second drain lines. The gate line is formed on an insulating substrate, and has a segment with both sides protruding to form first and second protrusion regions and an open region formed between the first and second protrusion regions to separate the segment into first and second portions. The first and second active layers are respectively formed on the first and second portions of the gate line. The first and second pixel electrodes are respectively formed on one side of the segment. The source line extends substantially perpendicular to the extension direction of the gate line to cross the respective overlapped regions of the first and second active layers and the gate line. The first and second drain lines, respectively coupled to the first and second pixel electrodes, extend substantially parallel to the extension direction of the source line. The first drain line crosses the overlapped region of the firstactive layer and the first portion. Similarly, the second drain line crosses the overlapped region of the second active layer and the second portion.

The invention provides a method for manufacturing a LCD comprising forming a gate line on an insulating substrate, wherein the gate line has a segment with one side protruding to form a protrusion region and an indentation region facing the protrusion region, forming an active layer on the segment of the gate line, forming a source line, and a drain line such that the source line extends substantially perpendicular to the extension direction of the gate line, across the overlapped region of the active layer and the gate line, and beyond the edges of the active layer, and the drain line extends from a predetermined pixel-electrode region to form a pixel electrode substantially parallel to the extension direction of the source line to cross the overlapped region of the active layer and the gate line, and forming the pixel electrode in the predetermined pixel-electrode region.

The invention provides another method for manufacturing a LCD comprising forming a gate line on an insulating substrate, wherein the gate line has a segment with both sides protruding to form first and second protrusion regions and an open region formed between the first and second protrusion regions to separate the segment into first and second portions, respectively forming first and second active layers on the first and second portions of the gate line, forming a source line on the first and second active layers and the insulating layers and first and second drain lines on the insulating substrate and respectively on the first and second active layers such that the source line extends substantially perpendicular to the extension direction of the gate line to cross the respective overlapped region of the first and second active layers and the gate line, and the first and second drain lines extend respectively from first and second predetermined pixel-electrode regions respectively to form first and second pixel electrodes, substantially parallel to the extension direction of the source line to respectively cross the respective overlapped regions of the first and second active layers and first and second portions, and respectively forming the first and second pixel electrode in the first and second predetermined pixel-electrode regions.

### BRIEF DESCRIPTION OF THE DRAWINGS

The invention can be more fully understood by reading the subsequent detailed description and examples with references made to the accompanying drawings, wherein:

FIG. 1 is a plane view of a pixel unit in a conventional TFT-LCD;

FIG. 2 is a plane view of the pixel unit in which the source electrode/drain electrode deviates to the right due to deviations in the exposure process;

FIG. 3 shows an equivalent circuit of a pixel unit in a TFT-LCD to illustrate the effect of C_{GD} on illumination;

FIGS. 4A and 4B are plane views of a pixel unit in a LCD in accordance with embodiments of the invention;

FIGS. 5A-5E are cross-sections at different steps in a fabrication process of a pixel unit in FIG. 4A

FIGS. 6A-6E are plane views at different steps in a fabrication process of a pixel unit of the invention corresponding to FIGS. 5A-5E.

FIG. 7 is a plane view of a pixel unit in a LCD in accordance with an embodiment of the invention; and

FIGS. 8A-8E are plane views at different steps in a fabrication process of a pixel unit in FIG. 7.

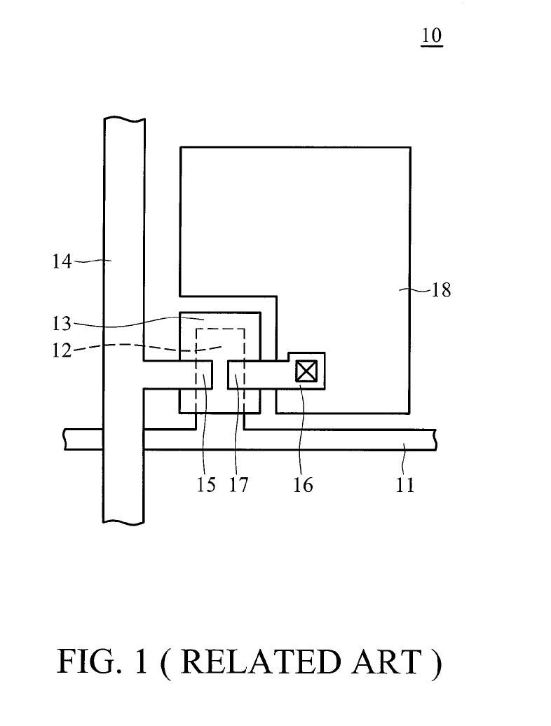

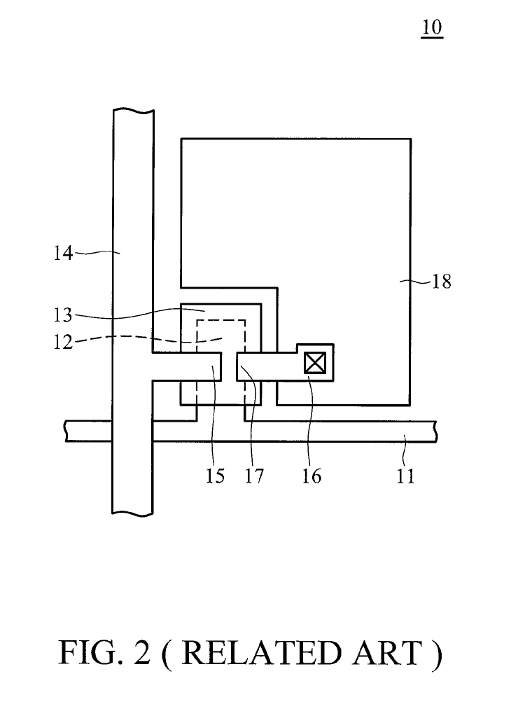

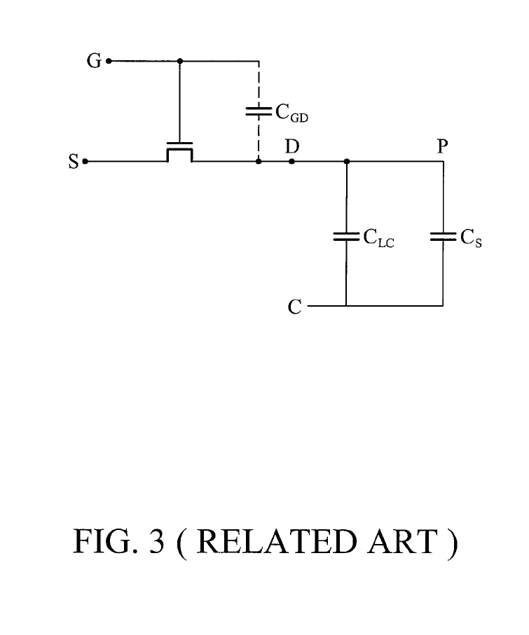

### DETAILED DESCRIPTION OF THE INVENTION

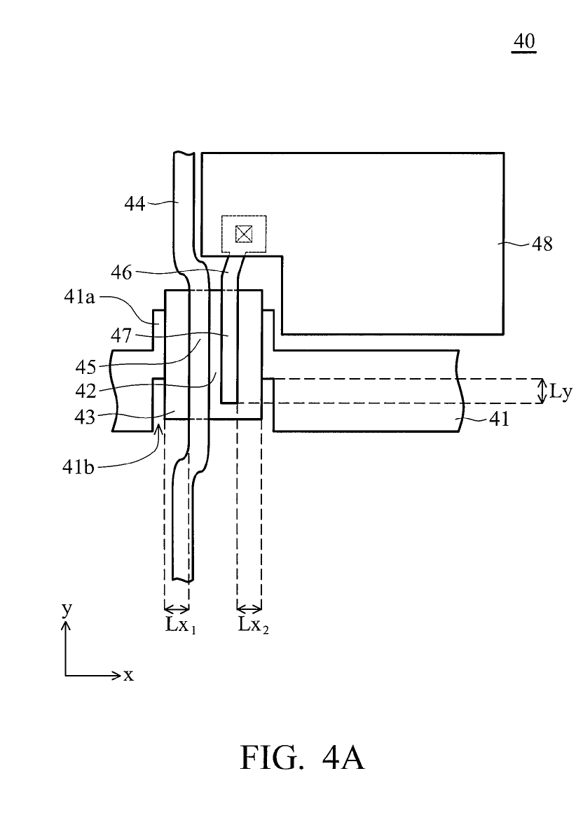

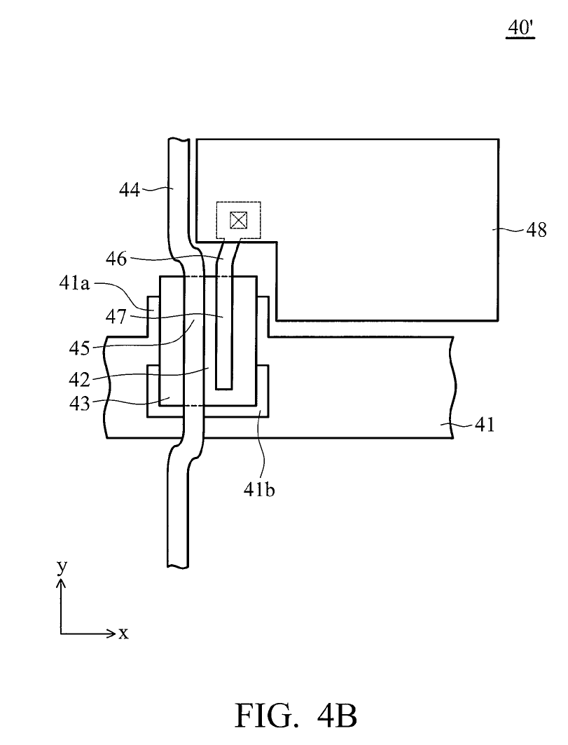

Referring to FIG. 4A, a plane view of a pixel unit 40 in a LCD in accordance with an embodiment of the invention. As shown in the figure, in the pixel unit 40, a gate line 41 is formed on an insulating substrate (not shown), wherein a segment of the gate line 41 has one side curving outwards to form a protrusion region 41a and another side curving inwards to form an indentation region 41b facing the protrusion region 41b. The segment serves as a gate electrode 42. An active layer 43 is formed on the gate electrode 42. A source line 44 extends substantially perpendicular to the gate line 41, across the overlapped region of the active layer 43 and the gate line 41 to form a source electrode 45 on the active layer 43, and prolongs beyond the boundary of the active layer 43. A drain line 46, coupled to a pixel electrode 48, extends substantially parallel to the source line 44 from the protrusion region 41a to the indentation region 41b, across the overlapped region of the active layer 43 and the gate line 41 to forming a drain electrode 47 on the active layer 43. A channel region is defined between the source electrode 45 and drain electrode 47 within the active layer 43. It is noted that in the figure the source line 44 bends slightly to the drain line 46. However, the source line 44 can be a straight line or extend substantially perpendicular to the gate line 41.

It can be seen that when size of the component varies with process resolution, the parasitic capacitor C_{GD} does not change accordingly. As shown in the figure, directions parallel and perpendicular to the gate line 41 are respectively denoted as X and Y. If exposure machine has an error of ±D_{X} along the direction X, distance between the boundaries of the source line 44 and the overlapped region of the active layer 43 and gate line 41 along the direction X is L_{X1}, and distance between the boundaries of the drain line 46 and the overlapped region of the active layer 43 and gate line 41 along the direction X is L_{X2}, then both distances L_{X1} and L_{X2} are required to be longer than distance D_{X}. Similarly, if exposure machine has an error of ±D_{Y} along the direction Y, and distance between the boundaries of the drain line 46 and the overlapped region of the active layer 43 and gate line 41 along the direction Y is L_{Y}, then distance L_{Y} is required to be longer than distance D_{Y}. If the above requirements are satisfied in a design, the overlapped region of the source electrode/drain electrode 45/47 and the gate line 42 and hence the parasitic capacitor C_{GD} can be fixed no matter the direction of the error of the exposure machine.

Further, to meet low resistance requirements of the gate line 41, the width of the gate line 41 can be increased, as shown in a pixel unit 40′ of FIG. 4B, an open region 41b thus facing the protrusion region 41a.

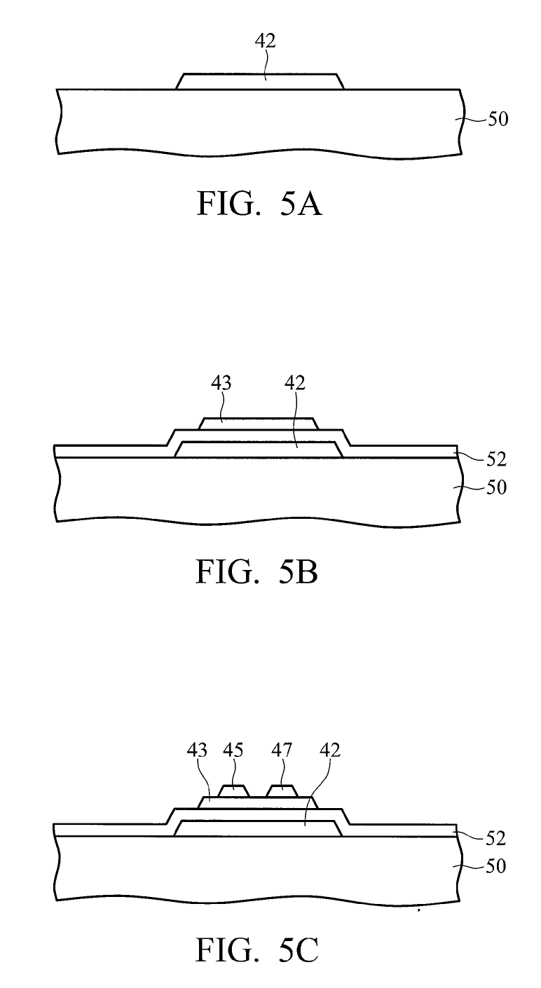

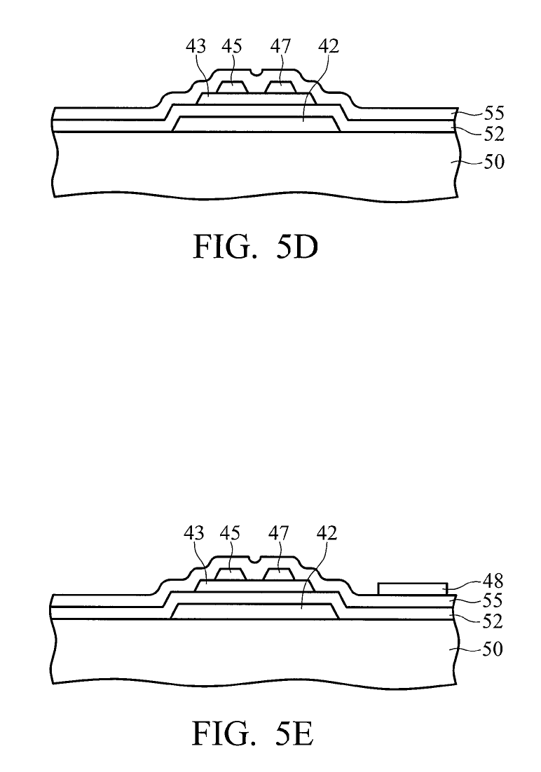

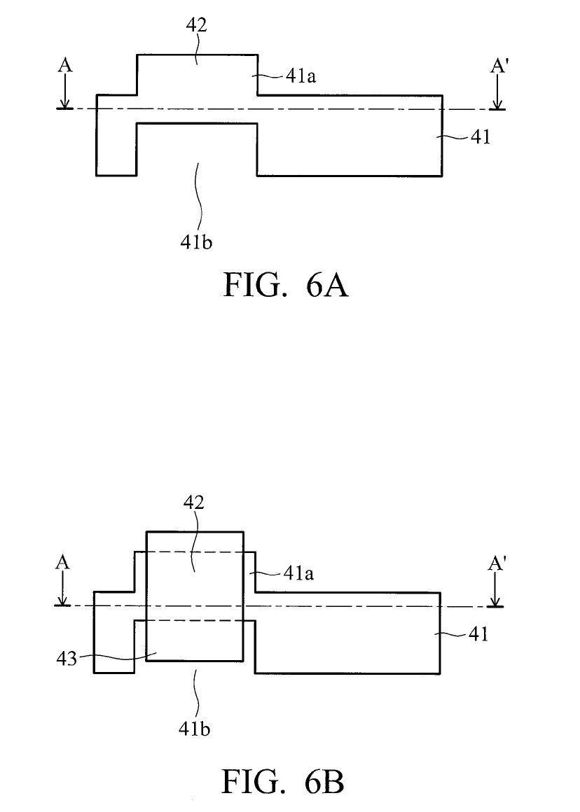

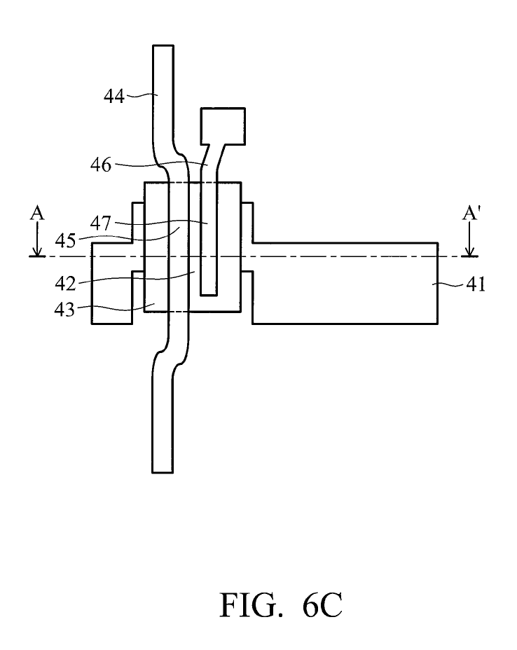

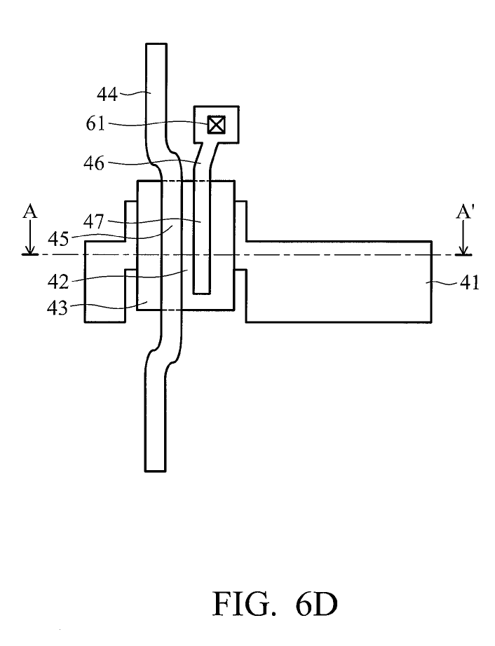

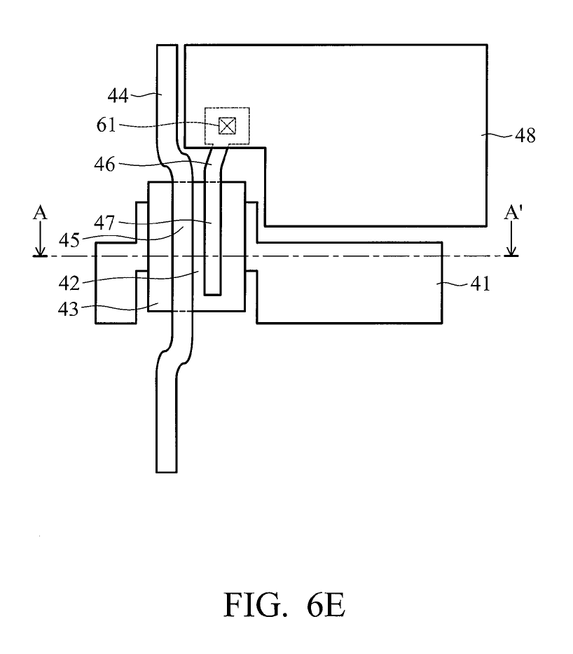

FIGS. 5A-5E and 6A-6E shows fabrication process of a pixel unit of the invention using the LCD shown in FIG. 4A as an example. FIGS. 6A-6E are plane views of the fabrication process and FIGS. 5A-5E are respective cross-sections along a line AA′ in FIGS. 6A-6E.

First, referring to FIG. 5A, a conductive film 41 is formed on an insulating substrate (such as a glass substrate) 50. The conductive film 41 is low resistant metal such as Al or Cr or alloy thereof, having a single or multiple layer structure formed by a conventional deposition such as sputtering. Next, the conductive film 41 is patterned by photolithograph etching, such that a gate line 41 having a gate electrode 42 is formed on the insulating substrate 50. As shown in FIG. 6A, the gate line 41 has a segment with one side curving outwards to form a protrusion region 41a and an indentation region 41a facing the protrusion region 41b. The segment serves as the gate electrode 42.

Next, referring to FIGS. 5B and 5C, a gate insulation film (such as a nitride layer) 52 and a semi-conductor layer 43 of an amorphous silicon material (such as a N-doped amorphous silicon) are sequentially formed on the entire upper surface of the resulting structure by a traditional deposition procedure such as plasma enhanced chemical vapor deposition (PECVD) process. Next, the semiconductor layer 43 is patterned to form an active layer 43 on the gate electrode 42 and the gate insulation film 52.

Next, referring to FIGS. 5C and 6C, a conductive film is formed on the entire upper surface of the resulting structure. The conductive film 41 is low resistance metal such as Al or Cr or alloy thereof, having a single or multiple layer structure formed by a conventional deposition such as sputtering. Next, the conductive film is patterned by photolithograph etching, such that a source line 44 and a drain line 46 are formed, wherein the source line 44 and the drain line 46 respectively have a source electrode 45 and a drain electrode 47 on the active layer 43. In FIG. 5C, the pattering is realized such that source line 44 extends substantially perpendicular to the gate line 41 and crosses the overlapped region of the active layer 43 and the gate line 41, and such that the drain line 46 extends substantially parallel to the gate line 41 from a predetermined pixel-electrode region where a pixel electrode is predetermined to be formed, crossing the overlapped region of the active layer 43 and the gate line 41.

Next, referring to FIGS. 5D and 6D, a passivation film 55, such as a nitride material, is formed on the entire upper surface of the resulting structure by conventional deposition such as PECVD. A contact hole 61 (not shown in FIG. 5D but shown in FIG. 6D) is sequentially formed within the passivation film 55 by photolithography etching such that a partial region of the drain line 46 is exposed.

Next, referring to FIGS. 5E and 6E, a transparent conductive layer having good transmissivity such as indium-tin-oxide (ITO) and indium-zinc-oxide (IZO) is formed on the upper surface of the resulting structure. The transparent conductive layer is sequentially patterned by etching so as to be connected to the exposed surface of the drain line and form a pixel electrode 48 on a partial region of the drain line 46 and the contact hole, and extends in the passivation film 55 adjacent to the active layer 43 and the TFT. The pixel electrode 48 is connected to the drain line 46 via the contact hole 56 in the passivation film 55.

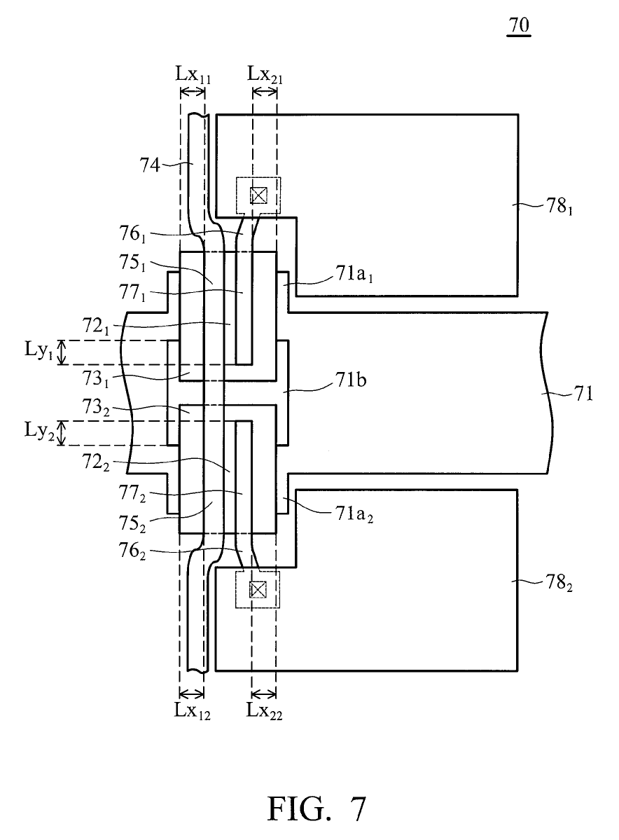

It is noted that the structure can extend to form a double-TFT LCD for the purpose of increasing conduction current. FIG. 7 is a plane view of such a pixel unit in a LCD comprising two shunted TFT transistors in accordance with an embodiment of the invention.

As shown in FIG. 7, in a pixel unit 70, a gate line 71 is disposed horizontally on an insulation substrate. A segment of the gate line 71 has two sides curving outwards to respectively form a first and second protrusion region 71a₁, and 71a₂, and has an open region 71b between the first and second protrusion regions 71a1 and 71a2 to separate the segment into first and second portions respectively serving as first and second gate electrode 72₁, and 72₂. A first and second active layer 73₁ and 73₂ are respectively formed on the first and second electrodes 72₁, and 72₂. A source line 74 extends substantially perpendicular to the gate line 71, crossing the overlapped region of the first active layer 73₁ and the first portion of the gate line 71 and the overlapped region of the second active layer 73₂ and the second portion of the gate line 71, and forming first and second source electrodes 75₁ and 75₂ respectively thereon. A first source line 76₁, extends substantially parallel to the source line 74 from a first pixel electrode 78₁ to cross the overlapped region of the first active layer 73₁ and the first portion of the gate line 71, forming a first drain electrode 77₁, thereon. Similarly, a second source line 762 extends substantially parallel to the source line 74 from a second pixel electrode 781 to cross the overlapped region of the second active layer 73₁ and the second portion of the gate line 71, forming a second drain electrode 77₂ thereon. Channels are defined respectively between the first source electrode 75₁ and the first drain electrode 77₁ in the first active layer 73₁ and between the second source electrode 75₂ and the second drain electrode 77₂ in the second active layer 73₂.

The structure is a double-TFT transistor comprising two shunted first and second TFT transistors. The first TFT transistor comprises first gate electrode 72₁, first active layer 73₁, first source electrode 75₁ and first drain electrode 77₁. The second TFT transistor comprises second gate electrode 72₂, second active layer 73₂, second source electrode 75₂ and second drain electrode 77₂. It is noted that the drain line 44 bends slightly to the drain line 46 in the figure. However, the source line 74 can be a straight line or extend substantially perpendicular to the gate line 71.

It is seen that when size of the components are determined according to process resolution, the parasitic capacitor C_{GD} will not change with process variance. As shown, distances between the boundaries of the source line 74 and the overlapped regions of the two active layer 73₁/73₂ and gate line 71 along the direction X are L_{X11} and L_{X21}, respectively, and distances between the boundaries of the drain lines 76₁, and 76₂ and the overlapped regions of the active layer 73₁ and 73₂ and gate line 71 are L_{X2l} and L_{X22} respectively along directions X, and are L_{Y1} and L_{Y2} respectively along direction Y. If exposure machine has errors of ±D_{X} and ±D_{Y} respectively along the directions X and Y, then when the distances LX₁₁, LX₁₂, LX₂₁ and LX₂₂ are designed longer than the distance D_{X}, and L_{Y1} and L_{Y2} longer than the distance L_{Y}, the overlapped region of the first source electrode/drain electrode 73₁/76₁, and the gate line 71, the overlapped region of the second source electrode/drain electrode 73₂/76₂ and the gate line 71, and hence the parasitic capacitor C_{GD} of the first and second TFT transistors are nearly fixed.

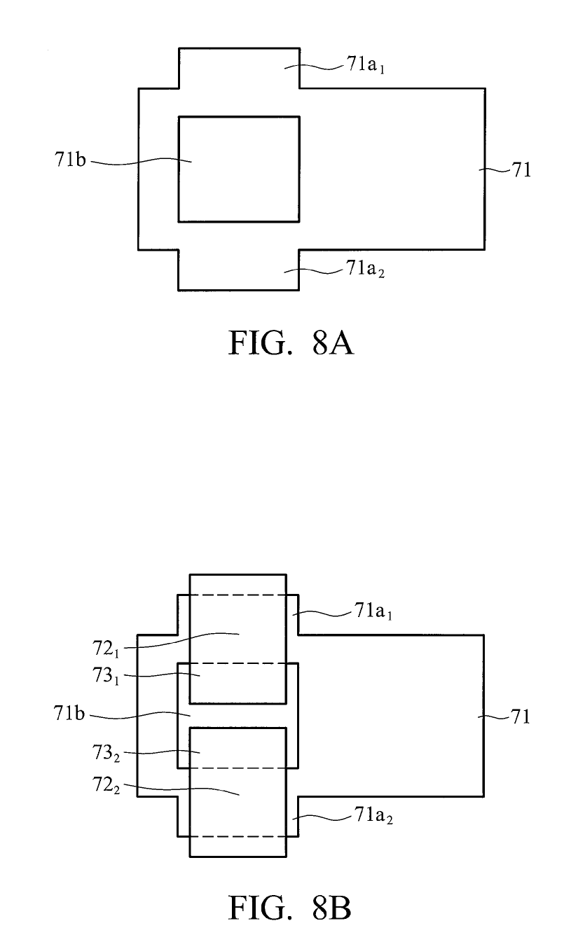

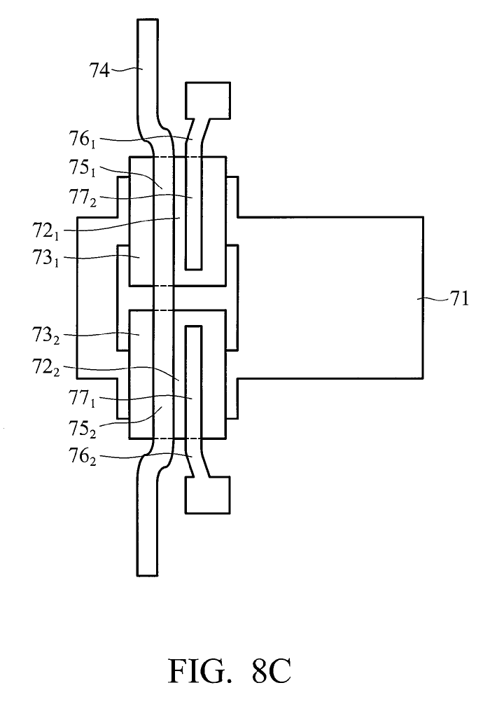

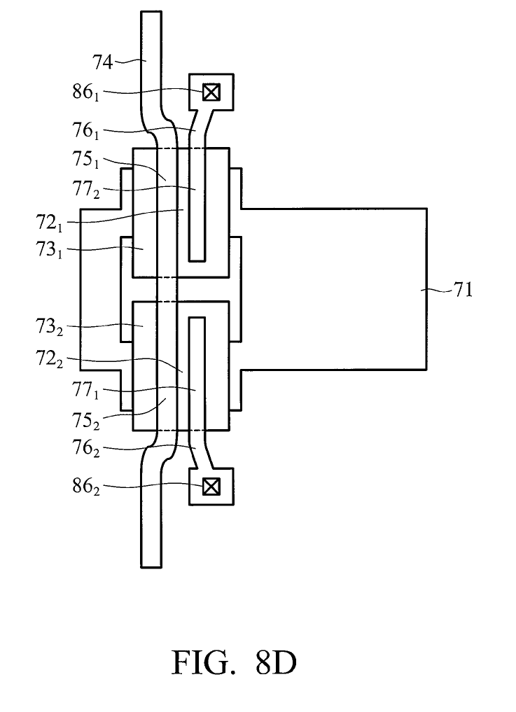

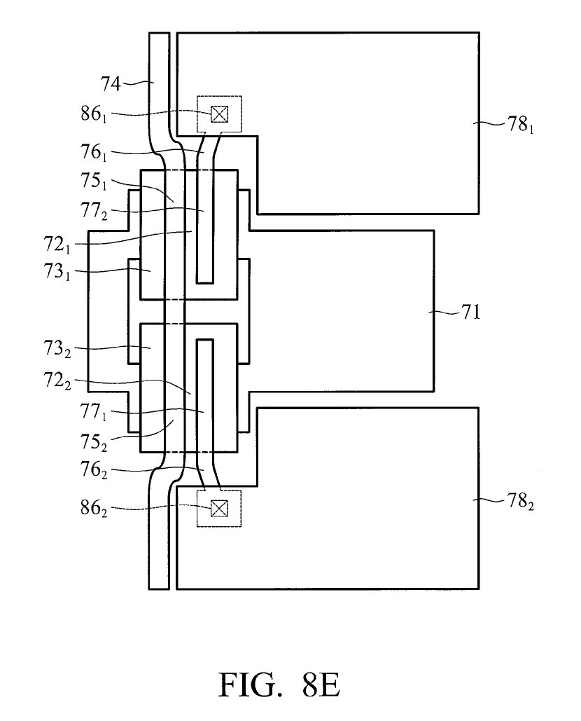

An LCD having double TFT transistors has fabrication process similar to that of the LCD having a single TFT transistor shown in FIG. 4A. FIGS. 8A-8E are plane views of a pixel unit of the LCD shown in FIG. 7 at different steps in a fabrication process. The cross-section is not described for brevity.

First, a conductive film is formed on an insulating substrate (such as a glass substrate). The conductive film is low resistant metal such as Al or Cr or alloy thereof, having a single or multiple layer structure formed by conventional deposition such as sputtering. Next, the conductive film is patterned by photolithograph etching, such that a gate line 71 is formed on the insulating substrate. As shown in FIG. 8A, the gate line 71 has a segment with both boundaries curving outwards to form first and second protrusion regions 71a₁, and 71a₂ and having an open space separating the segment into a first and second gate electrode 72₁, and 72₂.

Next, a gate insulation film (such as a nitride layer) is formed, and a semi-conductor layer of an amorphous silicon material (such as a N-doped amorphous silicon) is sequentially formed on the entire upper surface of the resulting structure by conventional deposition such as plasma enhanced chemical vapor deposition (PECVD) method. Next, the semiconductor layer is patterned to form first and second active layers 73₁ and 73₂ respectively on the first and second gate electrodes 72₁, and the neighboring gate insulation film, as shown in FIG. 8B.

Next, a conductive film is formed on the entire upper surface of the resulting structure. The conductive film is low resistant metal such as Al or Cr or alloy thereof, having a single or multiple layer structure formed by conventional deposition as sputtering. Next, the conductive film is patterned by photolithograph etching, such that a source line 74 and a first and second drain line 76₁, and 76₂ are formed. Referring to FIG. 8C, the pattering is performed such that source line 74 extends substantially perpendicular to the gate line 71 to cross the overlapped regions of the active layers 73₁ and 73₂ and the gate line 71, and such that the first and second drain line 76₁ and 76₂ extend substantially parallel to the gate line 74, each from a predetermined pixel-electrode region at one side of the gate line 71 where a pixel electrode is predetermined to be formed, crossing the overlapped region of the first and second active layers 73₁ and 73₂ and the gate line 71 respectively.

Next, a passivation film 55, such as a nitride material, is formed on the entire upper surface of the resulting structure by conventional deposition such as PECVD. First and second contact holes 86₁ and 86₂ are sequentially formed within the passivation film 55 by photolithography etching, such that respective partial regions of the first and second drain lines 76₁and 76₂ are exposed.

Next, a transparent conductive layer having good transmissivity such as indium-tin-oxide (ITO) and indium-zinc-oxide (IZO) is formed on the upper surface of the resulting structure. The transparent conductive layer is sequentially patterned by an etching method so as to be connected to the exposed surfaces of the first and second drain lines 76₁ and 76₂ and forms a first and second pixel electrode 78₁ and 78₂. Referring to the FIG. 8E, the pattering process is performed such that the first pixel electrode 86₁ is formed on a partial region of the first drain line 76₁, the first contact hole 86₁ and the passivation film adjacent to the first TFT. Similarly, the second pixel electrode 86₂ is formed on a partial region of the second drain line 76₂, the second contact hole 86₂, and the passivation film adjacent to the second TFT. Accordingly, the first pixel electrode 78₁ is connected to the first drain line 76₁ via the first contact hole 86₁, and similarly, the second pixel electrode 78₂ is connected to the second drain line 76₂ via the second contact hole 86₂.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A liquid crystal display (LCD), comprising:
a gate line formed on an insulating substrate, a segment of which has one side protruding to form a protrusion region and an indentation region facing the protrusion region;
an active layer formed on the segment of the gate line;
a pixel electrode formed on the protruding side of the segment;
a source line extending substantially perpendicular to the gate line to cross the overlapped region of the active layer and the gate line, prolonging beyond the edges of the active layer; and
a drain line, coupled to the pixel electrode, extending substantially parallel to the source line to cross the overlapped region of the active layer and the gate line

2. The LCD of claim 1, wherein the other side of segment facing the protrusion region curves inwards to serve as the indentation region.

3. The LCD of claim 1, wherein the segment has an open space facing the protrusion region to serve as the indentation region.

4. A liquid crystal display (LCD), comprising:
a gate line formed on an insulating substrate, having a segment with both sides protruding to form first and second protrusion regions and an open region formed between the first and second protrusion regions to separate the segment into a first and a second portions;
first and second active layers respectively formed on the first and second portions of the gate line;
first and second pixel electrodes respectively formed on one side of the segment;
a source line extending substantially perpendicular to the gate line to cross the respective overlapped region of the first and second active layers and the gate line; and
first and second drain lines, respectively coupled to the first and second pixel electrodes, extending substantially parallel to the source line wherein the first drain line crosses the overlapped region of the firstactive layer and the first portion, and the second drain line crosses the overlapped region of the second active layer and the second portion.

5. A method for manufacturing a liquid crystal device (LCD) comprising:
forming a gate line on an insulating substrate, wherein the gate line has a segment with one side protruding to form a protrusion region and an indentation region facing the protrusion region;
forming an active layer on the segment of the gate line;
forming a source line and a drain line, such that the source line extends substantially perpendicular to the gate line, crossing the overlapped region of the active layer and the gate line, and prolonging beyond the edges of the active layer, and the drain line extends from a predetermined pixel-electrode region to form a pixel electrode substantially parallel to the source line to cross the overlapped region of the active layer and the gate line; and
forming the pixel electrode in the predetermined pixel-electrode region.

6. The method of the claim 5, wherein the other side of segment facing the protrusion region curves inwards to serve as the indentation region.

7. The method of the claim 5, wherein the segment has an open space facing the protrusion region to serve as the indentation region.

8. A method for manufacturing a liquid crystal device (LCD) comprising:
forming a gate line on an insulating substrate, wherein the gate line has a segment with both sides protruding to form first and second protrusion regions and an open region formed between the first and second protrusion regions to separate the segment into first and second portions;
respectively forming first and second active layers on the first and second portions of the gate line;
forming a source line and a first and second drain lines on the first and second active layers and the insulating layers, such that the source line extends substantially perpendicular to the gate line, crossing the respective overlapped region of the first and second active layers and the gate line, and such that the first and second drain lines are extend respectively from first and second predetermined pixel-electrode regions respectively to form first and second pixel electrodes, substantially parallel to the source line, respectively crossing the respective overlapped regions of the first and second active layers and first and second portions; and
respectively forming the first and second pixel electrode in the first and second predetermined pixel-electrode regions.
